(19) United States
(12) Patent Application Publication
(10) Pub. No.: US 2025/0172423 A1
(43) Pub. Date: May 29, 2025

(54) SENSOR ASSEMBLY

(71) Applicant: Flusso Limited, Cambridgeshire (GB)

(72) Inventors: Andrea De Luca, Cambridgeshire (GB); John Charles Joyce, Cambridgeshire (GB); Cerdin Lee, Cambridgeshire (GB); Christopher James Rosser, Cambridgeshire (GB)

(73) Assignee: Flusso Limited, Cambridgeshire, GB (GB)

(21) Appl. No.: 19/026,025

(22) Filed: Jan. 16, 2025

Related U.S. Application Data
(62) Division of application No. 17/726,449, filed on Apr. 21, 2022.
Application No. 17/726,449 is a continuation-in-part of application No. PCT/EP2020/078299, filed on Oct. 8, 2020.

(51) Int. Cl. G01F 1/684

(52) U.S. Cl. CPC G01F 1/684; G01F 1/6842; G01F 1/6845; G01F 1/6847

(57) ABSTRACT

A flow sensor assembly comprising a first substrate, a flow sensor located over the first substrate, a lid located over the first substrate and the flow sensor, a flow inlet channel, a flow outlet channel, and an overmold laterally encircling the flow sensor. The overmold is in contact with the side walls of the flow sensor, and extends between the flow sensor and the lid such that the overmold, the flow sensor, and the lid define a flow sensing channel between the flow inlet channel and the flow outlet channel. the lid and the encapsulation cooperate to define the flow inlet channel and the flow outlet channel.

### CROSS REFERENCE TO RELATED APPLICATIONS

This application is a divisional of U.S. patent application Ser. No. 17/726,449, for “SENSOR ASSEMBLY” filed on Feb. 21, 2022, which is a continuation in part of PCT/EP2020/078299, for “SENSOR ASSEMBLY” filed on Oct. 8, 2020, which are hereby incorporated by reference in their entirety for all purposes.

### TECHNICAL FIELD

The present application relates to a fluid flow sensor assembly and a method of manufacturing a fluid flow sensor assembly.

### BACKGROUND

Thermal fluid flow sensors utilise the thermal interaction between the sensor itself and the fluid. Generally, a flow sensor assembly comprises a sensing die, a substrate, and a housing. In most cases, the housing comprises a flow channel with an inlet and an outlet. Electrical connections (e.g. bond wires) to the flow sensing die are often used. The channel is a fluidic element responsible for driving the fluid across the sensing die. The design of the flow channel strongly affects the performance of the flow sensing assembly (e.g. range, accuracy, noise, etc.).

In most electronic devices and sensors, the positioning of the package lid with respect to the device chip is not critical as long as the lid protects the device. However, in the case of flow sensors where the lid is an important part of the flow path, small misalignments between the lid and chip can affect the flow speed seen by the sensor chip and will affects its sensitivity and performance.

U.S. Pat. No. 10,151,612, EP 3032227, and U.S. Pat. No. 10,345,131 describe overmolded flow sensors. US 2014/0311912 describes modular microfluidic channel structures. US 2018/0172493, U.S. Pat. Nos. 4,548,078, 8,418,549, 8,695,417, 9,091,577, and 9,003,877 describe flow sensor assemblies.

### SUMMARY

Aspects and preferred features are set out in the accompanying claims.

According to a first aspect of the disclosure, there is provided a flow sensor assembly comprising:
a first substrate;
a flow sensor located over the first substrate;
a lid located over the first substrate and the flow sensor;
a flow inlet channel;
a flow outlet channel;
an overmold laterally encircling the flow sensor and in contact with the side walls of the flow sensor, wherein the overmold extends between the flow sensor and the lid such that the overmold, the flow sensor, and the lid define a flow sensing channel between the flow inlet channel and the flow outlet channel.

The flow sensor assembly may comprise a first substrate, a flow sensor located over the first substrate having a top surface comprising a flow sensing area, an encapsulation partially encapsulating the flow sensor and leaving at least the flow sensing area exposed, and a lid located over the encapsulation having a surface in contact with the encapsulation. The flow sensor assembly may also have first and second sides perpendicular to the top surface of the flow sensor, where the first and second sides may have at least one opening between the lid and encapsulation, or between the substrate and lid, and a first flow channel between these two openings. The fluid flow going through the first flow channel is referred to as ‘flowₛₑ’ and has a direction substantially parallel with the flow sensor top surface.

The overmold may also be referred to as an encapsulation. The flow sensing channel may extend in a first direction, laterally through the flow sensor assembly and parallel to a top surface of the flow sensor. The overmold may be a polymer material, for example, an epoxy.

The flow sensing channel may extend laterally through the device providing a fluid flow path laterally through the sensor assembly, past the flow sensor. A top surface of flow sensor may define a lower surface of the flow sensing channel.

The flow inlet channel, the flow outlet channel and the flow sensing channel together form the flow channel. The flow sensing channel may be defined as the whole length of the portion of the flow channel between the flow inlet channel and the flow outlet channel.

The lid and the encapsulation cooperate to define the flow inlet channel and the flow outlet channel. In other words, the flow inlet channel and the flow outlet channel may be defined by the cooperation of the shapes of the first substrate and the lid, and/or defined as a region between the first substrate and the lid either side of the flow sensing channel.

The flow inlet channel and the flow outlet channel may be defined on at least one surface of the flow sensor assembly, wherein the at least one surface is perpendicular to the top surface of the flow sensor. The flow inlet channel and the flow outlet channel may be defined on opposite surfaces of the flow sensor assembly. In other words, the flow inlet channel and flow outlet channel may be on opposite sides of the flow sensor such that fluid travels in one direction through the sensor. Fluid enters in same direction as it leaves, and therefore the sensor can be used in a continuous flow.

Alternatively, the flow inlet channel and the flow outlet channel may be defined on adjacent sides of the flow sensing assembly. The adjacent sides may be perpendicular to each other.

The flow sensing channel may comprise sloped sidewalls formed from the overmold. The sloped sidewalls may be sloped in relation to a lower surface of the flow sensing channel.

The overmold may be disposed at least partly over a top surface of the flow sensor.

The overmold may be configured such that a surface of the flow sensing channel is substantially flat in one direction between the flow inlet channel and the flow outlet channel. In use, once flow has passed through the flow inlet channel it reaches the flow sensing channel which may have a substantially flat surface. As a surface of the flow sensing channel may be substantially flat, the fluid flow through the flow sensing channel may flow parallel to the surface of the flow sensing channel and hits no or a reduced number of disturbances such as corners of the flow sensor (flow sensing die) within the flow sensing channel. The device therefore reduces turbulence through the sensor assembly, in particular around a flow sensing surface of the flow sensor, and improves the functionality of the flow sensor assembly.

As the overmold is at least partly disposed over a top surface of the flow sensor, it covers the corners of the flow sensor. Disturbances such as the corners of the flow sensor may be present are therefore not located within the flow sensing channel, and therefore do not increase turbulence in the flow sensing channel.

The surface of the flow sensing channel that is flat may be a first surface closest to the first substrate and defined by the flow sensor and the overmold. The surface that is substantially flat may include the surface of the flow sensor and a region of the flow sensing channel surface around the flow surface. Therefore, the surface of the flow sensor may be flush or level with the surface of the region around the flow sensor.

Alternatively, the surface that is substantially flat may be a second surface furthest from the first substrate and defined by the lid. Both the first and second surfaces of the flow sensing channel may be substantially flat to reduce turbulence.

The flow sensor assembly provides a miniature fluid flow sensor assembly manufacturable in very high volumes at low unit cost, whereby the onset of turbulences is reduced in proximity to the flow sensing structure to increase the flow sensing performance while maintaining a miniaturised form factor.

The flow sensor assembly may further comprise electrical contacts, such as bond pads and bond wires, coupling the flow sensor to the first substrate. The electrical contacts may be encapsulated within the overmold.

A first surface of the overmold may be substantially level with a top surface of the flow sensor. A lower surface of the flow sensing channel may be substantially flat through the length of the flow sensing channel.

The flow sensor assembly may comprise one or more structures configured to manipulate ‘flowₛₑ’ by engineering the flow sensing channel cross-sectional area along the channel length to improve the flow sensor assembly performance in terms of size, weight, sensitivity, accuracy, dynamic range, particles resilience, and/or robustness.

The flow channel may comprise one or more channel restrictors.

Restrictors may be placed at the flow inlet and flow outlet to reduce the effect on the flow sensing performance of the flow sensor assembly when integrated into the system using it. Restrictors may also be placed along the flow sensing channel in proximity of the flow sensing surface of the flow sensor to locally increase the flow speed and thus improve the flow sensing performance.

The one or more restrictors may be located on the lid. The restrictor may be configured to manipulate ‘flowₛₑ’. The restrictor may be located above the flow sensor to reduce the cross sectional area of the flow sensing channel in a region directly above the flow sensor, resulting in an ‘flowₛₑ’ velocity increase.

Alternatively, or additionally, the flow channel may comprise one or more protrusions located directly on and above the overmold and laterally spaced from the flow sensor. The protrusions may be monolithic with the overmold. The protrusions cause a localised increase of flow velocity in the region close to the protrusion. The protrusions may be located such that once the flow passes the protrusion and reaches the flow sensor (where cross-section area is larger), the flow will again slow down. The protrusion makes the flow better conditioned, for example it reduces flow turbulence, prior to the flow reaching the flow sensor. The protrusions thus improve or condition the flow before it reaches the flow sensing channel.

The flow sensor assembly may further comprise one or more guide structures located between the flow inlet channel and the flow outlet channel. The one or more guide structures may be located on or monolithic with the lid. The one or more guide structures may comprise one or more protrusions on an inner surface of the lid. The guide structures may be incorporated into or formed on a roof of the flow channel, that is provided by the lid. When incorporated into the lid, the guide structures may or may not extend down and contact the flow sensor or the encapsulation, forming a sealed channel.

The guide structures may at least partially separate the flow sensing channel from one or more regions between the inlet channel and outlet channel outside the flow sensing channel. The guide structures may be configured to separate the flow channel into one or more extra flow channels, with the flow sensing channel above the centre of the flow sensor, and one or more side channels laterally spaced from the flow sensor.

The guide structures may extend along a length of the flow sensing channel. The guide structures improve control of ‘flowse’ direction.

The lid may comprise a recess. The recess may be located on a first surface of the lid, wherein the first surface of the lid faces the flow sensor. The recess, the overmold, and the flow sensor may define the flow channel through the flow sensor assembly. Sidewalls of the recess of the lid may correspond with the sidewalls of the overmold. The recess increases the cross-sectional area of the channel, so that when the flow sensor assembly is placed within a much larger main channel, a larger proportion of the flow goes through the flow sensor assembly thereby improving sensor performance.

The flow sensor assembly may further comprise an additional flow channel formed by at least one further recess or aperture within the overmold and/or the lid. The flow sensor assembly may have first and second sides perpendicular to the top surface of the flow sensor. The first and second sides may have multiple openings between the lid and the encapsulation, or between the substrate and the lid, forming multiple flow channels between the multiple openings. The additional flow channels may include one or more structures configured to manipulate the flow within the additional flow channels.

The additional flow channel may be substantially parallel to the flow sensing channel. The flow sensor assembly may further comprise fins located within the additional flow channel.

The additional flow channel may be in a same plane as the flow sensing channel.

The additional flow channel and the flow sensing channel may both be connected to the same flow inlet channel and the same flow outlet channel. A portion of the fluid flow entering the flow inlet channel may travel directly through the additional channel instead of the flow sensing channel, bypassing the flow sensing channel.

The additional channel may have a larger cross-sectional area than the flow sensing channel and may directly extend between the flow inlet channel and the flow outlet channel. The flow sensing channel may be connected to the additional channel and may be parallel to the additional channel. In this instance, the additional channel may be referred to as a main channel and the flow sensing channel may be referred to as a bypass channel.

The additional flow channel may include one or more structures configured to manipulate the flow within the additional flow channels. The one or more structures configured to manipulate the flow may be either part of the lid or part of the encapsulation. Some examples of features are restrictors, guides, pressure drop elements, deflection fins, and additional in-plane or our-of-plane openings.

The additional flow channel may have a substantially larger cross-sectional area than the flow sensing channel.

The additional flow channel may be located above the flow sensing channel. The additional flow channel may be not located in the same plane as the flow sensing channel, and may be referred to as an out-of-plane bypass structure.

The overmold and/or the lid may be configured such that the flow inlet channel and/or the flow outlet channel have a larger cross-section than the flow sensing channel. A cross-sectional area of the flow inlet channel and/or the flow outlet channel tapers from a surface of the flow sensor assembly towards the flow sensing channel. The flow channel of the flow sensor assembly may have a tapered cross sectional area that is wider at the open ends of the flow inlet channel and the flow outlet channel, and is narrower in the flow sensing channel. The encapsulation, the lid, or both the encapsulation or the lid may have features adjacent to the open ends of the flow inlet channel and the flow outlet channel to provide a funnel shaped structure.

The flow sensor assembly may further comprise one or more spacers having a first surface located within 50 μm of, and more preferably in contact with, a surface of the flow sensor or a surface of the first substrate. The one or more spacers may have a second surface in contact with a first surface of the lid, wherein the first surface of the lid faces the flow sensor and the first substrate.

According to a further aspect of the disclosure, there is provided a flow sensor assembly comprising:
a first substrate;
a flow sensor mounted on a first surface of the first substrate;
a lid located over the first substrate and the flow sensor;
a flow inlet channel;
a flow outlet channel, wherein a surface of the flow sensor and a surface of the lid cooperate to form a flow sensing channel between the flow inlet channel and the flow outlet channel; and
a spacer having:
   a first surface located within 50 μm of a top surface of the flow sensor or a top surface of the first substrate, wherein the top surface of the flow sensor or the first substrate faces the lid; and
   a second surface in contact with a first surface of the lid, wherein the first surface of the lid faces the flow sensor.

The flow sensor assembly may comprise a flow sensor chip on a package substrate, and a lid covering the package substrate, where the lid forms part of the flow channel. The flow sensor assembly may comprise structures to ensure alignment of the lid to the sensor chip and/or the package substrate. The alignment structures can be for horizontal, vertical, and/or rotational alignment. Preferably the alignment ensure horizontal, vertical, and rotational alignment. The purpose of ensuring alignment is to improve consistency of the geometry of the flow path for the fluid being sensed, and thus improve consistency of performance between different sensors. The alignment structures could also be combined with, or incorporated into, flow and/or vortex guides.

The first surface of the spacer may be in contact with a top surface of the flow sensor or a top surface of the first substrate, and the top surface of the flow sensor or the top surface of the first substrate may face the lid.

The flow sensor assembly may comprise: a first substrate; a flow sensor located over the first substrate; a lid located over the flow sensor; a flow inlet channel; a flow outlet channel, wherein a surface of the flow sensor and a surface of the lid cooperate to form a flow sensing channel between the flow inlet channel and the flow outlet channel; and wherein there are alignment structures to improve alignment and positioning of the lid with respect to either the flow sensor and/or the first substrate.

As the lid of the flow sensor assembly defines the flow sensing channel, misalignments between the lid and chip can affect the flow speed seen by the sensor chip and will affects its sensitivity and performance. The use of alignment structures therefore can help to align the lid better during the packaging process, resulting in better device performance, and better reproducibility from device to device.

The alignment structures may be configured to improve vertical alignment, horizontal alignment, or rotational alignment. Vertical alignment can be improved by use of structures that extend from the lid to the top of the sensor chip or to the first substrate. In package assembly, the lid may be lowered until these structures touch the sensor chip or the first substrate. Horizontal alignment can be improved by having structures with corner or side brackets in the lid that align with the corners or sides of the flow sensor. Such structures will also provide rotational alignment. During assembly of the flow sensor assembly, an optical method may be used to ensure alignment of the lid to the flow sensor, or the lid may be moved until it drops into place. A device may have only vertical alignment structures, or only horizontal alignment structures, or may comprise separate structures for vertical and horizontal alignment, or structures that provide the function of both vertical and horizontal alignment.

The lid may laterally encircle the flow sensor.

A second surface of the lid may be in contact with a second surface of the first substrate, by way of an adhesive. The second surface of the lid may face the same direction as the first surface of the lid. The second surface of the first substrate may face the same direction as the first direction of the first substrate.

The second surface of lid may comprise one or more recesses configured to receive the adhesive.

The first surface of the spacer may be in contact with a top surface of the flow sensor, wherein the top surface of the flow sensor faces the lid. A bottom surface of the flow sensor may be in contact with the first surface of the first substrate, by way of an adhesive, wherein the first surface of the first substrate faces the lid.

The one or more spacers may extend from a first inside edge of the lid to a second inside edge of the lid. The one or more spacers may extend across an entire width of the internal volume of the flow sensor assembly in a second direction. The one or more spacers may define the flow sensing channel between the flow inlet channel and the flow outlet channel.

The one or more spacers may be configured to be located within 50 μm of, and more preferably in contact with, at least one side surface of the flow sensor. The first surface of the one or more spacers may be chamfered. Alternatively, a surface of the one or more spacers that is perpendicular to the first spacer may be chamfered.

The one or more spacers may be in direct contact with the flow sensor, alternatively the spacer may not be in direct contact with the flow sensor assembly but may be located within a distance of 50 μm of at least one side surface of the flow sensor. This allows for manufacturing tolerances of the spacers and the flow sensing die.

The one or more spacers or alignment structures may act as guide structures and may completely separate or isolate the flow sensing channel from the one or more regions or additional flow channels between the inlet channel and outlet channel outside the flow sensing channel. The flow sensor assembly may comprise bond wires electrically connected to the flow sensor, and the alignment structures may separate the bond wires from the flow sensing channel. The bond wires may be located in the one or more regions between the inlet channel and outlet channel outside the flow sensing channel.

The flow sensor assembly may further comprise one or more extension members laterally adjacent to the flow sensor. The extension members may be one or more separate components in physical contact with the flow sensor or may be one or more extended portions of the flow sensor itself.

One or more of the flow inlet channel, the flow outlet channel, or the flow sensing channel may comprise one or more channel restrictors. The channel restrictors may be formed at any location within the flow channel. The term ‘channel restrictors’ is used to refer to restrictors located within the flow channel.

The flow sensing channel guiding the fluid from the inlet to the outlet results from the assembly of the lid on top of the substrate. The bottom face (or first surface) of the flow sensing channel may be formed by the extension member (which can be a filler material) and the flow sensing surface of the flow sensing die. Bond wires may be perpendicular to the fluid flow and positioned in such a way to reduce their interaction with the fluid flow and thus reduce the onset of unwanted turbulences.

The flow channel may have any cross-sectional geometry (e.g. square, rectangular, semi-circular, irregular etc.). The cross-section geometry may also vary along the length of the flow channel (e.g. the cross-section of the flow channel may be circular at the inlet and square at the flow sensing die section of the flow sensing channel).

A specific case of non-uniform flow channel cross-sectional area is using restrictors (i.e. the flow channel cross-sectional area is locally reduced). Restrictors may be placed at the flow inlet and flow outlet to reduce the effect on the flow sensing performance of the flow sensor assembly when integrated into the system using it. Restrictors may also be placed along the flow sensing channel in proximity of the flow sensing surface of the flow sensing die to locally increase the flow speed and thus improve the flow sensing performance.

Another specific case of non-uniform flow channel cross-sectional area is using reservoirs or plenums (i.e. the flow channel cross-sectional area is locally enlarged). Reservoirs may also be placed at the flow inlet and flow outlet or along the flow sensing channel. By using plenums, at the point at which the flow inlet and/or flow outlet meet the flow sensing channel, there is a region within the flow inlet and/or flow outlet channel that has a much larger cross-sectional area than the remaining portion of the flow inlet/outlet channel. Plenums may be placed at either the flow inlet or flow outlet or both.

Also, the flow sensing channel may run straight from the inlet to the outlet, may have a serpentine shape from the inlet to the outlet or may have any other shape engineered to improve flow sensor assembly performance.

The extension member may comprise a filler material adjacent to the flow sensor and on the first substrate. The filler material or gel may extend across a remaining width of the flow sensing channel where the flow sensor is not present, and may have a substantially flat top surface across the width of the flow sensing channel. The filler material may extend to substantially the same height above the first substrate as the flow sensor height above the first substrate such that the flow sensor and the filler material together form a flat surface (the first surface of the flow sensing channel) across the entire length of the flow sensing channel. In other words, the surface of the filler material may be flush with the surface of the flow sensor to form one flat surface throughout the entire length of the flow sensing channel.

The flow sensor assembly may further comprise a rim to retain the filler material. The rim may be an integral part of the first substrate, the lid, or may be a separate component of the flow sensor assembly.

The substrate may comprise a rim; and the rim may be integral part of the substrate. Alternatively, the rim may be an integral part of the lid or an additional element assembled onto the substrate as part of the flow sensor assembly process. As a result, a cavity between the rim and the flow sensing die is formed. To reduce turbulences in proximity to the flow sensing surface of the flow sensing die the cavity may be filled with a filler material. Depending on the filler deposition method, the surface topology of the filler may be concave or convex. Interestingly the filler material also protects the substrate bond pads and offers partial protection to the bond wires.

The shape of the rim may have sloping, vertical or backward sloping side walls, as long as the cavity within the rim contains the flow sensing die. The rim may circumnavigate the package and may be done so using any shape (e.g. circular, square, oval, square with rounded edges).

The filler material may be any material (e.g. a polymer, more specifically a gel, a resin, an epoxy, a ceramic, a metal, a semiconductor, or a combination of those) with suitable electrical, thermal, mechanical and chemical properties. The filler material is electrically insulating, thermally conductive, thermo-mechanically stable (i.e. does not expand or contracts in time and/or when exposed to varying temperatures), chemically stable (i.e. does not absorb, adsorb, desorb molecules in time). The filler material may be deposited (e.g. printed, syringe dispensed, sprayed, etc.) in ways compatible with the other elements forming the flow sensing assembly with high reproducibility. A curing step may be used to change the phase of the filler from fluid to solid.

The filler material may be configured such that it does not overlap an upper surface of the flow sensor. The filler material may have a concave or convex meniscus due to surface tension.

Alternatively, the filler material may slightly overlap the flow sensor when the flow sensor is heated up when in use. This may be achieved using a filler material with a concave or convex meniscus. Although the filler material may be configured to reduce the overlap between the filler material and the flow sensor in this case.

The flow sensor assembly may comprise bond wires electrically connected to the flow sensor, and the filler material may be configured to cover the bond wires. The filler material may fully encapsulate the bond wires; this reduces turbulence due to the bond wires. Alternatively, the filler material may partly encapsulate the bond wires and the bond wires may be configured to have reduced interaction with the fluid flow through the fluid flow sensor assembly.

Due to surface tension effects, the filler material may fully encapsulate the bond wires and the die bond PADs for extra protection.

The extension member may comprise an extension portion of the flow sensor. The extension portion may be an integral part of the flow sensor. The extension portion can be a region of a substrate and a dielectric layer, or could be other form of extension portion of a different type of flow sensor without a substrate and a dielectric layer.

The lid may define one or more apertures, and the flow inlet channel may comprise a channel through one of the apertures. The flow inlet channel may be configured to be substantially perpendicular to the flow sensing channel, and the extension member may extend underneath the flow inlet channel. The extension member may extend along the entire width of the inlet channel. These features allow fluid flow from the flow inlet channel to flow onto a substantially flat surface without disturbances when reaching the flow sensing channel.

Alternatively, or additionally the flow outlet channel may comprise a channel through one of the apertures. The flow outlet channel may be configured to be substantially perpendicular to the flow sensing channel, and the extension member may extend underneath the flow outlet channel.

A top surface of the lid may be substantially flat such that the flow inlet channel and the flow outlet channel terminate on the top surface of the lid. The top surface may be defined as the exterior surface of the lid that extends in a lateral direction, substantially parallel to the flow sensing channel. The apertures or openings defining the flow inlet channel and the flow outlet channel may be flat.

Alternatively, the lid may comprise one or more protrusions on an outer surface of the lid, and the one or more apertures may extend through one or more of the protrusions. The protrusions may comprise hoses. The protrusions may extend away from the flow sensing channel.

The protrusions may be substantially perpendicular to the flow sensing channel, and the flow inlet channel and flow outlet channel may then be substantially perpendicular to the sensing channel. In this embodiment, fluid enters and exits the flow sensor in opposite directions.

Alternatively, the protrusions may be substantially parallel to the sensing channel, and the flow inlet channel and flow outlet channel may then be substantially parallel to the sensing channel. In this embodiment, fluid enters and exits the flow sensor in the same direction.

The flow sensor assembly may comprise a lid with a flow inlet and a flow outlet both comprising hoses to facilitate mechanical connection to the system using it. Hoses may have any geometry used to facilitate mechanical connection to the system using the flow sensor assembly. For instance, the hoses may have barbs, grooves, protrusions or a combination of those to enhance friction with the pipes or any other mean connected to them. The number, size and position within the flow sensor assembly of the inlet and the outlet might vary depending on the application requirements.

The first substrate and the lid may cooperate to define the flow inlet channel and the flow outlet channel. In other words, the flow inlet channel and the flow outlet channel may be defined by the cooperation of the shapes of the first substrate and the lid, and/or defined as a region between the first substrate and the lid either side of the flow sensing channel.

The lid further may comprise a lid restrictor, and the extension member may extend under the whole length of the lid restrictor. The term ‘lid restrictor’ is used to refer to a restrictor formed on the lid. The lid restrictor may be located on a lower surface of the lid. The lower surface of the lid may be defined as the surface of the lid that defines the flow sensing channel and is on the interior of the flow sensor assembly.

The lid may comprise a restrictor, placed along the flow channel in proximity of the flow-sensing surface of the flow sensor to locally increase the flow speed and thus improve the flow sensing performance. This may be used in applications where the flow sensor assembly is soldered on a surface over which a fluid is flowing, and the application requires measuring a property of the flowing fluid. This may be used in embodiment with a rim and filler material, or in embodiments where the extension member is an extended portion of the flow sensor.

The flow sensor assembly may further comprise an integrated circuit or circuitry located between the flow sensor and the first substrate. In other words, the first substrate, the integrated circuit, and the flow sensor may be formed in a stack in the order of first substrate, integrated circuit and flow sensor. In embodiments with filler material, the filler material may encapsulate the integrated circuit.

The flow sensor assembly may further comprise an integrated circuit or circuitry located laterally spaced from the flow sensor and over the first substrate, wherein the one or more extension members covers the integrated circuitry. In other words, the flow sensor and the integrated circuitry may be located side-by-side on the first substrate. The extension member may fully cover the integrated circuitry. In embodiments with filler material, the filler material may encapsulate the integrated circuit.

The flow sensor assembly may also comprise an integrated circuit (IC) die. The flow sensor may be stacked on top of the IC die to reduce the overall flow sensor assembly form factor. Alternatively, the flow sensing die and the IC die may be assembled side-by-side. In both cases, the filler material may offer protection to the IC die. The flow sensing die may be connected to the IC die directly through bond wires or indirectly through electrical connections through the substrate. The flow sensing die may have through silicon vias (TSV), to avoid the presence of bond wires and even further reduce the onset of unwanted turbulences. Advantageously, a flow sensor with TSV can help with 3D stacking techniques, whereby the flow sensing die sits on top of an IC (e.g. ASIC), thus reducing the sensor system size.

Alternatively or additionally, circuital blocks may be integrated on to the flow sensor itself. The membrane of the flow sensor may occupy a small area of the flow sensing surface, leaving a lot of area for monolithic integration of circuital blocks within the flow sensing die. Circuitry may comprise IPTAT, VPTAT, amplifiers, analogue to digital converters, digital to analogue converters, memories, RF communication circuits, timing blocks, filters or any other means for driving, readout, and electrical signals manipulation and communication to the outside world. For instance, in case of a thermal flow sensor, a heating element driven in constant temperature mode results in enhanced performance and having on-chip means to implement this driving method would result in a significant advancement of the state-of-the-art flow sensors. Also the driving method known a 3ω may be implemented via on-chip means, or any other driving method, such as constant temperature difference and time of flight, needed to achieve specific performance (e.g. power dissipation, sensitivity, dynamic response, range, fluid property detection).

The spacer may be monolithic with the lid.

The flow sensor assembly may further comprise a restrictor located on the lid, and the second surface of the spacer may be in contact with the restrictor.

The flow sensor may comprise:
a sensor substrate comprising an etched portion;
a dielectric layer located on the sensor substrate, wherein the dielectric layer comprises at least one dielectric membrane located over the etched portion of the sensor substrate; and
a sensing element located on or within the dielectric membrane.

The sensing element may comprise a metal layer located within the dielectric membrane. The metal layer may comprise a heater, a temperature sensor or other type of sensing element used in a flow sensor.

The sensing element may comprise means to sense one or more properties of the fluid (e.g. velocity, flow rate, exerted wall shear stress, absolute pressure, differential pressure, temperature, direction, thermal conductivity, diffusion coefficient, density, specific heat, kinematic viscosity). The flow sensor may be a thermal flow sensor, and said means to sense one or more properties of the fluid may include heating elements and temperature sensors. The flow sensor may be a mechanical flow sensor, and said means to sense one or more properties of the fluid may include piezo elements.

The starting substrate may be silicon, or silicon on insulator (SOI). However, any other substrate combining silicon with another semiconducting material compatible with state-of-the-art CMOS fabrication processes may be used. Employment of CMOS fabrication processes guarantees sensor manufacturability in high volume, low cost, high reproducibility and wide availability of foundries supporting the process. CMOS processes also enable on-chip circuitry for sensor performance enhancement and system integration facilitation.

The membrane or membranes may be formed by back-etching using Deep Reactive Ion Etching (DRIE) of the substrate, which results in vertical sidewalls and thus enabling a reduction in sensor size and costs. However, the back-etching may also be done by using anisotropic etching such as KOH (Potassium Hydroxide) or TMAH (TetraMethyl Ammonium Hydroxide) which results in sloping sidewalls. The membrane may also be formed by a front-side etch or a combination of a front-side and back-side etch to result in a suspended membrane structure, supported only by 2 or more beams. The membrane may be circular, rectangular, or rectangular shaped with rounded corners to reduce the stresses in the corners, but other shapes are possible as well.

The dielectric membrane may comprise of silicon dioxide and/or silicon nitride. The membrane may also comprise of one or more layers of spin on glass, and a passivation layer over the one or more dielectric layers. The employment of materials with low thermal conductivity (e.g. dielectrics) enables a significant reduction in power dissipation as well as an increase in the temperature gradients within the membrane with direct benefits in terms of sensor performance (e.g. sensitivity, frequency response, range).

The dielectric region may comprise a dielectric layer or a plurality of layers including at least one dielectric layer. Generally speaking, a dielectric membrane region may be located immediately adjacent to the etched portion of the substrate. The dielectric membrane region corresponds to the area of the dielectric region above (or below depending upon the configuration) the etched cavity portion of the substrate. For example, in a flip-chip configuration the dielectric membrane will be shown below the etched cavity portion of the substrate. Each dielectric membrane region may be over a single etched portion of the semiconductor substrate.

The flow sensor may comprise a passivation layer located on the dielectric layer.

A top surface of the passivation layer may be configured to be non-planar. The top surface of the passivation layer may be defined as the surface that is adjacent to the flow sensing channel or the flow sensing surface. The top surface of the passivation layer may comprise protrusions extending away from the dielectric layer. The protrusions may comprise walls or ridges. Stacks may be used within the dielectric layer to support the walls or ridges.

Walls may be present on the flow sensing surface of the flow sensing die. In case the filler material bleeds onto the flow sensing surface of the flow sensing die, the walls act as barrier for the filler material thus avoiding interaction of the filler material with the flow sensing structure of the flow sensing surface of the flow sensing die. The walls may be a by-product of a non-planarised fabrication process. For example, metal structures within a metal layer may be realised, resulting in a flow sensing surface with extrusions following the pattern of the metal structures within the metal layer. This effect may be further enhanced if metal structures are realised within different metal layers on top of each other.

A top surface of the passivation layer may comprise one or more grooves. The grooves, trenches or recesses may be etched portions of the passivation layer. These allow excess filler material to extend or bleed into the grooves, for example when the sensor assembly is heated in use. This reduces bleeding of the filler material over the membrane.

Grooves or recesses may be present on the flow sensing surface of the flow sensing die. In case the filler material bleeds onto the flow sensing surface of the flow sensing die, the grooves act as an accumulation volume for the filler material. This avoids interaction of the filler material with the flow sensing structure of the flow sensing surface of the flow sensing die.

The protrusions of the passivation layer may be used as an alternative or in addition to the grooves within the passivation layer. This reduces bleeding of the filler material onto the dielectric membrane, which would reduce functionality of the flow sensor.

The dielectric membrane may define a through-hole. The through hole or aperture may extend through the membrane to allow fluid to flow through the flow sensor.

To facilitate the assembly process and reduce failures during soldering of the flow sensor assembly, the membrane may comprise through holes (or membrane cavity vent holes). The vent holes reduce any pressure increase within the membrane cavity that may result in membrane breakages, damage or stress.

The flow sensor assembly may comprise a coating on surfaces that are in contact with fluid flow through the device, ‘flowₛₑ’. The coating may comprise a protective layer. The coating can be engineered to provide the flow sensor assembly with enhanced resilience to particles, humidity, condensation, corrosive fluids and any other substance that can potentially affect the performance or lifetime of the flow sensor assembly.

The flow sensor assembly may further comprise bond pads located on an outer surface of the flow sensor assembly. The first substrate may comprise additional bond pads, referred to as internal bond pads. The flow sensor may comprise additional bond pads, referred to as die bond pads. The outer surface of the flow sensor assembly may be plastic, and the (outer) bond pads may be made of metal. The outer bond pads may form an electrical connection between the outer surface of the assembly and the internal bond pads of the lead frame (first substrate). The internal bond pads may form an electrical connection to the die bond pads through bond wires.

The flow channel walls may be partly or fully covered and protected by a protective layer. The protective layer may be a conformal layer, thus following the topology of the flow channel walls. The bond wires may also be conformally coated by the protective layer. Anything else within the flow channel that in absence of the protective layer would be in contact with the fluid flow may also be conformally coated by the protective layer.

The entire flow sensor assembly (not only the flow channel walls) may be coated by the conformal protective layer.

Alternatively, the protective layer may be deposited at wafer level. In this case, only the flow sensing die would be protected by the protective layer.

The protective layer may also be deposited during or at the end of the assembly process. In these cases, only part of the flow sensor assembly or the entire flow sensor assembly would be protected by the protective layer.

The protective layer may protect fragile elements of the flow sensor assembly from aggressive media (e.g. aggressive liquids, corrosive gases, etc.) and also improve biocompatibility of the flow sensor assembly for example in medical applications and generally avoid direct interaction of some or all the elements forming the flow sensor assembly with the fluid under test and/or the environment.

The first substrate may define an aperture. The aperture of the first substrate and the through-hole of the dielectric membrane may form a hole through the flow sensor assembly. The aperture reduces any pressure build up in the cavity underneath the membrane, thus reducing the risk of failure during packaging of the flow sensing die onto the substrate and during soldering of the flow sensor assembly onto a second substrate (e.g. a PCB).

According to a further aspect of the disclosure, there is provided a flow sensing system comprising:
a main channel extending in a first direction;
a flow sensor assembly as described above, wherein the flow sensor assembly is located in the main channel such that the flow sensing channel of the flow sensor assembly is substantially parallel to the main channel. The flow sensor assembly may be located within a larger pipe or tube, referred to as the main channel. The main channel may have a substantially large cross sectional area than the flow sensing channel. The flow sensor assembly may be disposed on a sidewall of the larger pipe or tube.

In this setup, a portion of the flow going through the main channel may also go through the flow sensor assembly.

The flow sensor assembly may be integrated on one side of a main flow channel with a substantially greater cross-section area than the first flow channel. The fluid flow going through this second channel may be referred to as ‘Flow_{SY}’ and may have a direction substantially parallel with ‘flowₛₑ’.

The flow sensor assembly may be located within the main flow channel such that the flow sensing channel of the flow sensor assembly is parallel with the main flow channel. The flow sensor assembly may have openings corresponding to the open ends of the flow inlet channel and the flow outlet channel located on two opposite sides of the flow sensor assembly.

Alternatively, the flow sensor assembly may be rotated at an angle less than 90° with respect to the main flow channel, more particularly, the flow sensor assembly may be rotated at angle of 45° with respect to the second main such that the flow sensing channel extends in a direction non-parallel to the main flow channel. The flow sensor assembly may have openings corresponding to the open ends of the flow inlet channel and the flow outlet channel, located on two adjacent sides of the flow sensor assembly rather than on opposite sides.

According to a further aspect of the disclosure, there is provided a method of manufacturing a flow sensor assembly, the method comprising:
forming a first substrate;
forming a flow sensor located over the first substrate;
forming a lid located over the first substrate and the flow sensor;
forming a flow inlet channel;
forming a flow outlet channel;
forming an overmold laterally encircling the flow sensor and in contact with the side walls of the flow sensor, wherein the overmold extends between the flow sensor and the lid such that the overmold, the flow sensor, and the lid define a flow sensing channel between the flow inlet channel and the flow outlet channel, and wherein the lid and the encapsulation cooperate to define the flow inlet channel and the flow outlet channel.

According to a further aspect of the disclosure, there is provided a method of manufacturing a flow sensing system, the method comprising:
providing a main channel extending in a first direction;
manufacturing a flow sensor assembly according to the method as described above;
positioning the flow sensor assembly within the main channel such that the flow sensing channel of the flow sensor assembly is substantially parallel to the main channel.

### BRIEF DESCRIPTION OF THE FIGURES

Some embodiments of the disclosure will now be described by way of example only, and with reference to the accompanying drawings, in which:

FIG. 1A shows schematically a cross-section of a flow sensor assembly within a larger channel, according an embodiment of the disclosure;

FIG. 1B shows an alternative cross-section of the flow sensor assembly shown in FIG. 1A;

FIG. 1C shows a top view of the flow sensor assembly shown in FIGS. 1A and 1B;

FIG. 2A shows schematically a cross-section of an alternative flow sensor assembly having a restrictor in the lid;

FIG. 2B shows an alternative cross-section of the flow sensor assembly of FIG. 2A;

FIG. 3 shows schematically a cross-section of an alternative flow sensor assembly having guide structures located on the lid;

FIG. 4 shows schematically a cross-section of an alternative flow sensor assembly having tapered inlet and outlet openings formed by the lid and the encapsulation;

FIG. 5 shows schematically a cross-section of an alternative flow sensor assembly having a recess in the lid;

FIG. 6 shows schematically a cross-section of an alternative flow sensor assembly having a protrusion formed on the encapsulation;

FIG. 7 shows schematically a cross-section of an alternative flow sensor assembly having a protrusion on the encapsulation and a restrictor feature on the lid;

FIG. 8 shows schematically a cross-section of an alternative flow sensor assembly having additional side channels;

FIG. 9 shows schematically a top view of an alternative flow sensor assembly having a by-pass channel within the package;

FIG. 10 shows schematically a top view of an alternative flow sensor assembly having a by-pass channel within the package, and restrictors and fins within the flow path;

FIG. 11A shows schematically a cross-section of an alternative flow sensor assembly having an out-of-plane by-pass channel;

FIG. 11B shows schematically another cross-section of a flow sensor assembly having an out-of-plane by-pass channel;

FIG. 12 shows schematically a cross-section of an alternative flow sensor assembly having a protective coating within the flow channel;

FIG. 13 shows schematically a cross-section of an alternative flow sensor assembly having vertical alignment structures;

FIG. 14 shows a top view of the flow sensor assembly shown in FIG. 13;

FIG. 15 shows schematically a cross-section of an alternative flow sensor assembly with alignment structures that operate as a flow guide;

FIG. 16 shows a top view of the flow sensor assembly shown in FIG. 15;

FIG. 17 shows schematically a top view of a flow sensor assembly having horizontal alignment structures;

FIG. 18 shows a cross-section of the flow sensor assembly shown in FIG. 17;

FIG. 19 shows schematically a top view of an alternative flow sensor assembly having horizontal alignment structures;

FIG. 20 shows a cross-section of the flow sensor assembly shown in FIG. 19;

FIG. 21 shows schematically a top view of an alternative flow sensor assembly having horizontal alignment structures;

FIG. 22 shows a cross-section of the flow sensor assembly shown in FIG. 21;

FIG. 23 shows schematically a top view of an alternative flow sensor assembly having horizontal alignment structures;

FIG. 24 shows a cross-section of the flow sensor assembly shown in FIG. 23;

FIG. 25A shows schematically a top view of a flow sensor assembly;

FIG. 25B shows a cross-section of the flow sensor assembly shown in FIG. 25A;

FIG. 25C shows an alternative cross-section of the flow sensor assembly shown in FIGS. 25A and 25B;

FIG. 26 shows schematically a cross-section of an alternative flow sensor assembly having the inlet and outlet each comprising a restrictor and the flow sensing die stacked on top of the ASIC;

FIG. 27 shows schematically a cross-section of an alternative flow sensor assembly having the flow sensing die arranged side by side with the ASIC;

FIG. 28 shows schematically a cross-section of an alternative flow sensor assembly having the inlet and outlet located above the flow sensing die;

FIG. 29 shows schematically a cross-section of an alternative flow sensor assembly having the inlet and outlet arranged parallel to the flow channel;

FIG. 30 shows schematically a cross-section of an alternative flow sensor assembly having the inlet and outlet arranged parallel to the flow;

FIG. 31 shows schematically a cross-section of an alternative flow sensor assembly having filler material protecting the bond wires;

FIG. 32 shows schematically a cross section of a flow sensing die having grooves on the flow sensing die surface;

FIG. 33 shows schematically a cross section of a flow sensing die having walls on the flow sensing die surface;

FIG. 34A shows schematically a cross-section of an alternative flow sensor assembly having recesses on the lid to receive adhesive;

FIG. 34B shows schematically a cross section of a flow sensing assembly having recesses on the lid to receive adhesive and with excess lid attach present; and

FIG. 34C shows schematically a cross section of a flow sensing assembly having recesses on the lid to receive adhesive, with excess lid attach present along, and having an epoxy recess link.

### DETAILED DESCRIPTION OF THE PREFERRED EMBODIMENTS

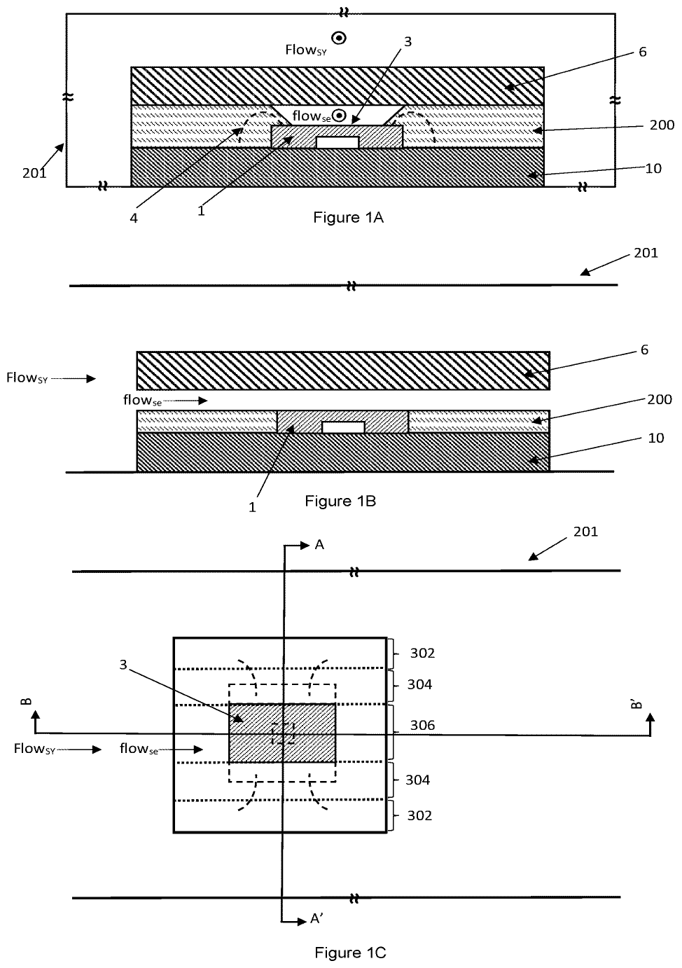

FIGS. 1A to 1C show a flow sensor assembly according to the disclosure. FIG. 1C shows a top view of the flow sensor assembly, FIG. 1A shows a cross-section of the device of FIG. 1C taken along the line A-A′, and FIG. 1B shows a cross-section of the device of FIG. 1C taken along the line B-B′.

The flow sensor assembly includes a flow sensor 1 comprising a flow sensing area 3 above a substrate 10. Bond wires 4 form an electrical connection between the flow sensor 1 and the substrate 10. An encapsulation or overmold 200 covers part of the flow sensor 1 and substrate 10, and also covers the bond wires 4, but leaves the flow sensing area 3 exposed. A lid 6 is placed above the encapsulation such that the lid is in contact with the top surface of the encapsulation 302.

The top surface of the flow sensor 1, the encapsulation 200 and the lid 6 together define a flow sensing channel through the flow sensor assembly. The encapsulation 200 is deposited such that it is level with a top surface of the flow sensor 1 in central region parallel to the direction of flow to form a lower surface 306 of the flow sensing channel. The encapsulation 200 forms sloped sidewalls 304 of the flow sensing channel.

The flow sensor assembly has first and second sides perpendicular to the top surface of the flow sensor 1, where the first and second sides have one opening between the lid 6 and the encapsulation 200, or between the substrate 10 and the lid 6, and the flow sensing channel between these two openings. The flow sensor assembly is placed in a much bigger flow path 201, for example the larger flow path 201 may be a larger channel or pipe. The flow sensor assembly is on an interior surface of the larger channel 201 and is placed such that the flow sensing channel through the flow sensor assembly is parallel to the direction of flow, Flow_{SY}, through the larger channel 201. Flow through the sensor assembly, flowₛₑ, can enter the flow sensor assembly, travel through the flow sensor assembly, and leave the flow sensor assembly with minimal disturbance.

The fluid flow going through the first flow channel is referred to as ‘flowₛₑ’ and has a direction substantially parallel with the flow sensor top surface as indicated by the dotted circle symbol. The flow sensor assembly is integrated on one side of a main flow channel with a substantially greater cross-section area than the first flow channel. The fluid flow going through this second channel may be referred to as ‘Flow_{SY}’ and may have a direction substantially parallel with ‘flowₛₑ’ as indicated by the dotted circle symbol.

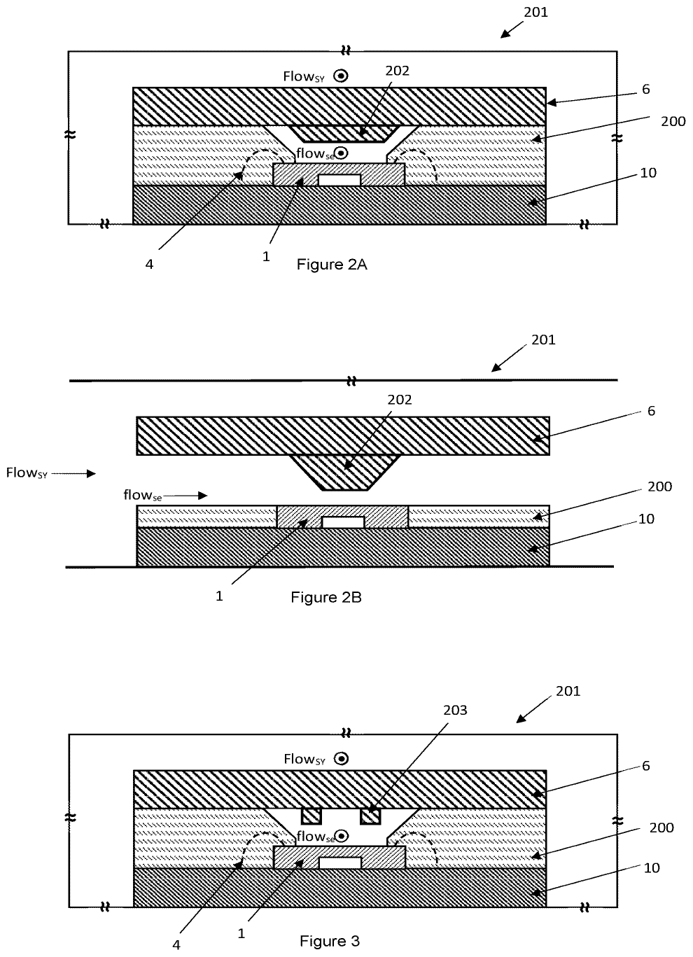

FIG. 2A shows a cross-section of a cross-section of an alternative flow sensor assembly having a restrictor 202 in the lid (taken along the line A-A′ shown in FIG. 1C), and FIG. 1B shows a cross-section of the device of FIG. 2A taken along the line B-B′.

The flow sensor assembly of FIG. 2 is similar to that shown in FIG. 1, however there is a restrictor 202 on the lid 6. The restrictor 202 is located above the flow sensing surface 3 of the flow sensor 1, thereby narrowing the flow sensing channel above the flow sensor 1. This helps to improve the flow above the flow sensing area 3, and hence the sensitivity of the device.

FIG. 3 shows a cross-section of an alternative flow sensor assembly having guide structures 203 located on the lid 6, and directly above the flow sensing surface 3 of the flow sensor. The guide structures 203 extend in the direction of flow, flowₛₑ, through the flow sensor assembly. The guide structure 203 improve the flow within the flow sensing channel and thus improve the sensitivity of the flow sensor assembly.

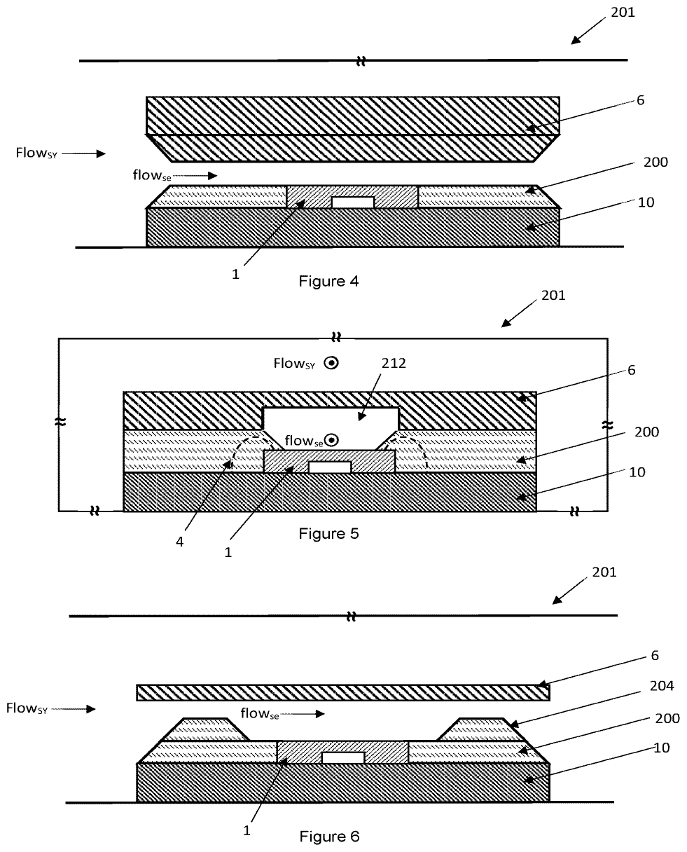

FIG. 4 shows schematically a cross-section of an alternative flow sensor assembly having tapered inlet and outlet openings formed by the lid 6 and the encapsulation 200. As such, the flow inlet channel and the flow outlet channel of the flow sensor assembly have a larger cross-sectional area at the sides of the flow sensor assembly, than the cross-sectional area of the flow sensing channel through the device. The tapered inlet and outlet openings allow a larger portion of the main flow within a larger flow channel in which the flow sensor assembly is located, to go through the flow sensor assembly. This improves the sensitivity of the flow sensor assembly. In this example, both the lid 6 and the encapsulation 200 have a greater thickness towards the centre of the device to form the tapered openings, however only the lid 6 or the encapsulation 200 may have a greater thickness towards the centre of the device.

FIG. 5 shows a cross-section of an alternative flow sensor assembly having a recess 212 in the lid. In this example, the sidewalls of the recess 212 are aligned with the sidewalls of the flow sensing channel formed by the overmold 200, such that the cross-sectional area of the flow sensing channel is increased. The recess 212 increases the amount of fluid flowing through the flow path.

FIG. 6 shows schematically a cross-section of an alternative flow sensor assembly having a protrusion 204 located on the encapsulation 200. The protrusions 204 may be monolithic with the overmold 200. In this example, the protrusions are laterally spaced from the flow sensor to cause a flow velocity increase close to the protrusions, whilst allowing the flow velocity to reduce towards its original value before reaching the flow sensor. The protrusions improve the flow conditioning before it reaches the flow sensing channel.

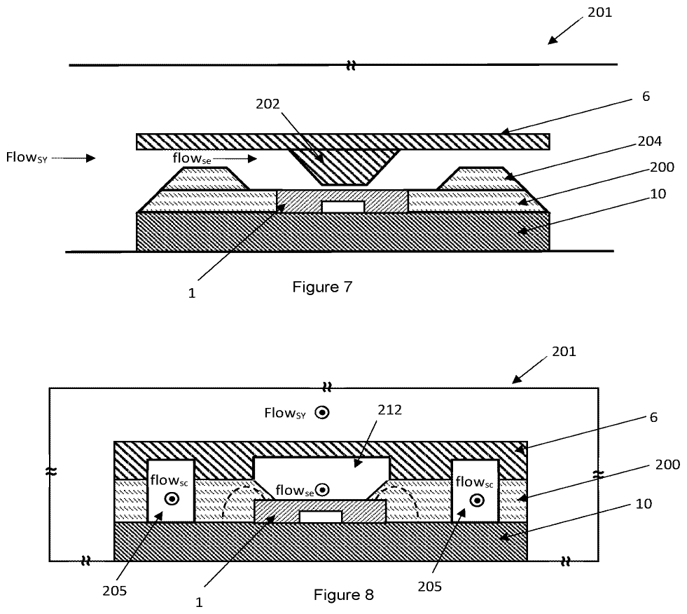

FIG. 7 shows schematically a cross-section of an alternative flow sensor assembly having a protrusion 204 on the encapsulation and a restrictor 202 on the lid. The restrictor 202 is similar to that shown in FIG. 2, and the protrusions 204 are similar to those shown in FIG. 6. The protrusion may also be referred to as a bump. The bump can be located anywhere inside the flow sensing channel outside of the flow sensing area, and there can be one or more bumps. The restrictor 202 in the lid 6 can be preferably above the flow sensing area, but can also be in other regions along the path, and there can be more than one restrictor. The restrictor 202 and bumps 204 can also be tapered as shown in the figure, or can be square or curved shape.

FIG. 8 shows schematically a cross-section of an alternative flow sensor assembly having additional side channels 205. In this example, the additional side channel 205 may or may not be connected to the flow sensing channel. The additional side channels 205 prevent unwanted turbulences within the flow, flowₛₑ, within the flow sensing channel.

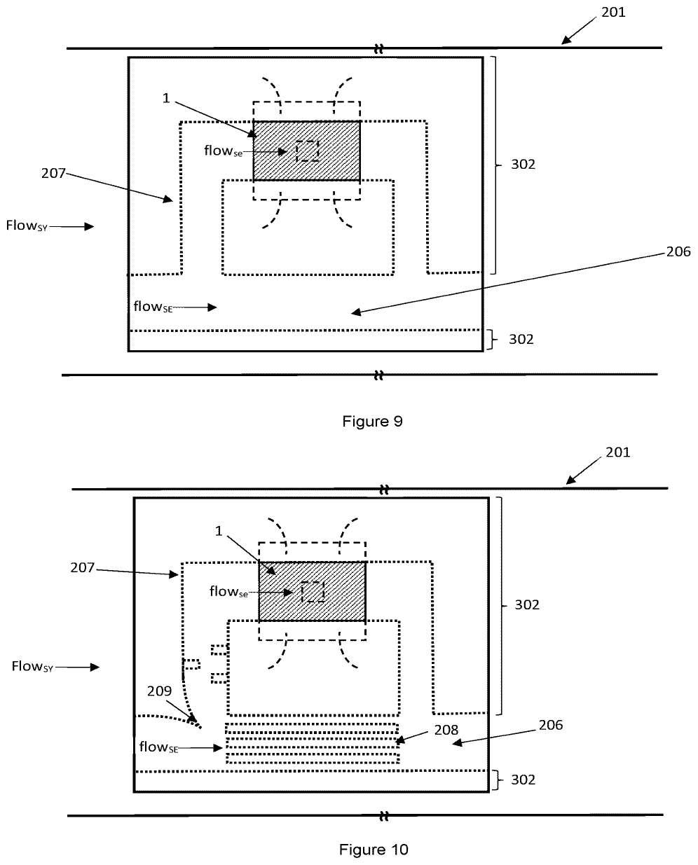

FIG. 9 shows a top view of an alternative flow sensor assembly having a by-pass channel 207 within the package. In the embodiments shown in FIGS. 9 and 10 there is one main channel 206 through the flow sensor assembly, and one by-pass flow path 207 forming the flow sensing channel. The main channel 206 and the by-pass channel 207 are located within the same plane. The main channel 206 and the by-pass channel 207 are both connected to the same flow inlet channel and the same flow outlet channel, and the by-pass flow path 207 is connected to and parallel to the main channel 206. The flow sensor 1 is placed within the by-pass flow path 207. The flow travelling through the flow sensing channel, flowₛₑ, is a portion of the total flow entering the flow sensor assembly, flow_{SE}. In this way, the flow sensor is not exposed to the larger flow, flow_{SE}, and is only exposed to the smaller flow, flowₛₑ. This is useful when the flow rate, flow_{SE}, in the main channel 206 is very high. It also protects the flow sensor against dust particles that may be present in the main channel 206, but are less likely to be present in the by-pass flow path 207.

The flow sensor assembly of FIG. 10 is similar to that shown in FIG. 9. In the embodiment shown in FIG. 10, there are fins 208 present in the main flow path. There is also a restriction feature 209 present. Both of these features help to improve the fluid flow through the flow paths. The restriction 209 reduces the chances of particles in flow from reaching the flow sensing channel. The fins 208 are horizontal partition in the direction of flow and help to make the flow laminar. Further elements such as guide structures, pressure drop elements, or additional openings may also be present.

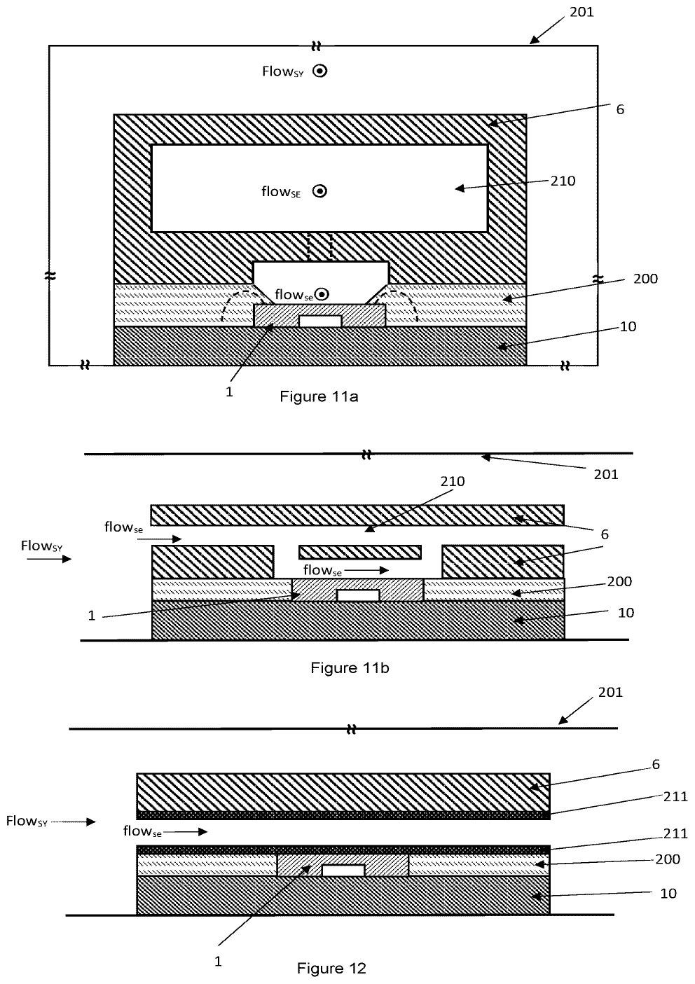

FIG. 11 shows schematically a cross-section of an alternative flow sensor assembly having with an out-of-plane by-pass channel;

FIGS. 11A and 11B show another example of a flow sensor assembly where there is a main flow channel 210 and a bypass flow path forming the flow sensing channel. Similar to FIGS. 9 and 10, the main flow channel 210 and flow sensing channel are both connected to the same flow inlet channel and the same flow outlet channel, and the by-pass flow path is connected to and parallel to the main channel 210. The flow sensor 1 is located within the bypass channel. In this embodiment, the main flow channel 210 and by-pass flow path are separated vertically. In the embodiment shown, the main flow channel 210 is located within the lid 6.

The main channel 210 has a larger cross sectional area than the flow sensing channel. As such, similar to the embodiment shown in FIGS. 9 and 10, the flow travelling through the flow sensing channel, flowₛₑ, is smaller than the flow travelling through the main channel 210, flow_{SE}. In this way, the flow sensor is not exposed to the larger flow, flow_{SE}, and is only exposed to the smaller flow, flowₛₑ.

FIG. 12 shows a cross-section of an alternative flow sensor assembly having a protective coating 211 within the flow channel. In this embodiment, the protecting coating 211 is located over the lower surface of the lid, the upper surface of the encapsulation 200 and the upper surface of the flow sensor 1 that together define the flow sensing channel. The coating protects the sensor against corrosive fluids.

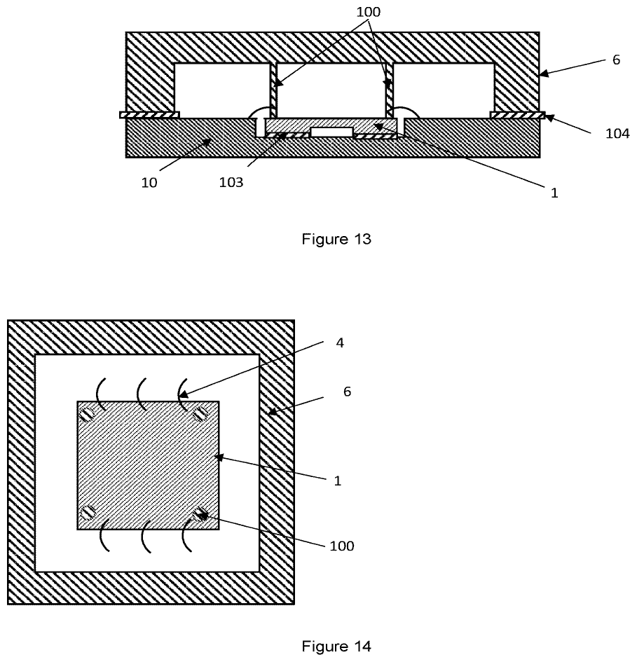

FIG. 13 shows a cross-section of an alternative flow sensor assembly having vertical alignment structures, and FIG. 14 shows a top view of the flow sensor assembly shown in FIG. 13. In the embodiment of FIG. 13 and FIG. 14, there are alignment structures on the lid 6 that define the vertical distance between the lid 6 and the flow sensor 1, thereby defining the height of the flow sensing channel. The alignment structures may also be referred to as spacers.

A flow sensor chip 1 is attached to a substrate 10 by means of a die attach 103. A lid 6 is attached to the substrate by means of a lid attach 104. In this embodiment, the die attach 103 and the lid attach 104 may be an adhesive joining the flow sensor 1 and the substrate 10 and the lid 6 and the substrate 10 respectively. However, the die attach 103 and the lid attach 104 may be another fixing means. The lid 6 has vertical alignment structures 100 to allow better alignment of the lid with the flow sensor chip 1. By contacting the top of the sensor chip 1, the effect of tolerances in the lid attach 103 thickness and the die attach 104 thickness can be reduced or eliminated. The alignment structure 100 may limit the minimum height of the flow channel (in situations where the alignment structures 100 do not contact the top of the flow sensor 1), and may define the exact height of the flow sensing channel (in situations where the alignment structures 100 do contact the top of the flow sensor 1).

In this embodiment, the alignment structures 100 are shown as 4 cylindrical supports located in line with the corners of the flow sensor 1 to reduce the effect of the alignment structures 100 on flow within the flow sensing channel. However, there may be more or less alignment structures and they may be aligned with different regions of the flow sensor 1.

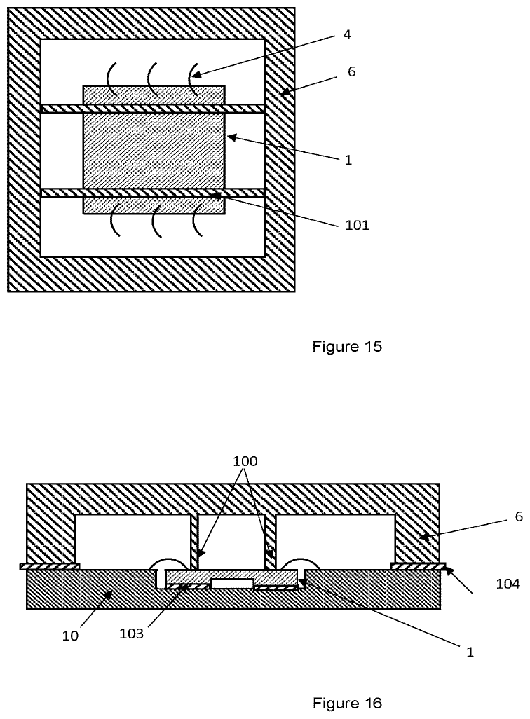

FIG. 15 shows a cross-section of an alternative flow sensor assembly with alignment structures 101 that operate as a flow guide, and FIG. 16 shows a top view of the flow sensor assembly shown in FIG. 15. The alignment structures 101 of FIGS. 15 and 16 are similar to those shown in FIG. 13, however in this embodiment they are provided as two structures extending laterally through the flow sensor assembly parallel to two opposite edges of the flow sensor 1.

FIG. 15 and FIG. 16 illustrate how a single set of features 101 could define both the vertical alignment between the flow sensor 1, the lid 6, and the substrate 10, and also can further define sidewalls of the flow sensing channel through the flow sensor assembly and over the sensor chip 1. In this embodiment, the alignment structures 101 are aligned with an area of the flow sensor 1 in between the two sets of bond wires 4, so that the bond wires 4 are located outside the alignment structures 101 and the sidewalls of the flow sensing channel. The alignment structures 101 act as flow guides.

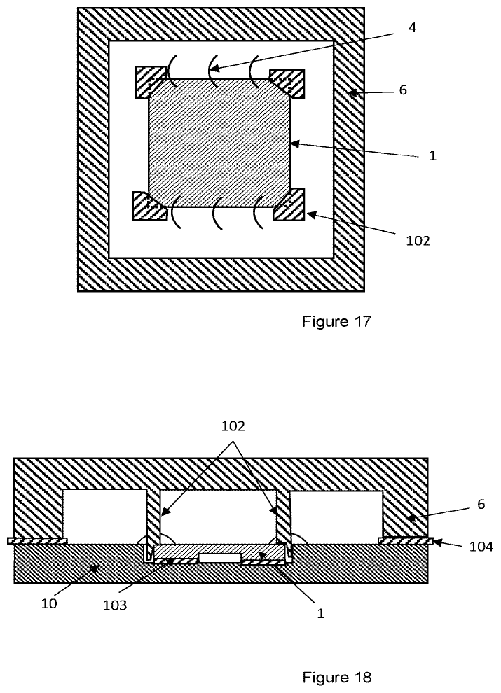

FIG. 17 shows a top view of a flow sensor assembly having horizontal alignment structures 102, and FIG. 18 shows a cross-section of the flow sensor assembly shown in FIG. 17. FIG. 17 and FIG. 18 illustrate how lid alignment features 102 could be used to define the vertical alignment between the flow sensor 1, the lid 6, and the substrate 10, and the horizontal alignment between the lid 6 and the sensor chip 1. As shown in FIG. 17, the alignment structures 102 overlap with the flow sensor 1 and an area outside the flow sensor. A lower, inner corner of each alignment structure 102 overlapping with a respective corner of the flow sensor 1 is chamfered, as shown when viewed from the side in FIG. 18, so that both horizontal and vertical alignment is achieved automatically as the lid 6 is lowered onto the sensor chip 1 and package substrate 6.

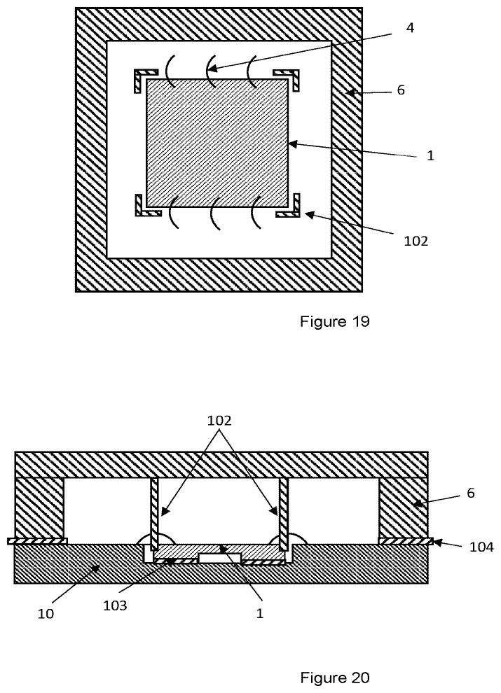

FIG. 19 shows a top view of an alternative flow sensor assembly having horizontal alignment structures, and FIG. 20 shows a cross-section of the flow sensor assembly shown in FIG. 19. In this embodiment, the alignment structures 102 are supports having an L shape when viewed from the top and are aligned around each corner of the flow sensor 1 so that each corner of the flow sensor 1 is surrounded by an alignment structure 102. In this embodiment, there are four structures 102—one aligned with each corner of the flow sensor 102. However, there may be less than four alignment structures.

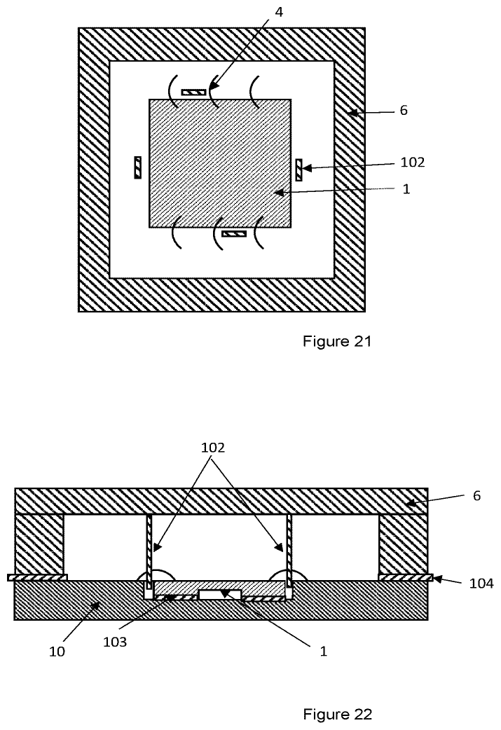

FIG. 21 shows a top view of an alternative flow sensor assembly having horizontal alignment structures, and FIG. 22 shows a cross-section of the flow sensor assembly shown in FIG. 21. In this embodiment, the alignment structures 102 are flat structures and aligned with and laterally spaced from the side edges of the flow sensor 1. In this embodiment, four structures 102 are shown-one aligned with each edge of the flow sensor. However, there may be less than four alignment structures. The alignment structures 102 that are aligned with the sides of the flow sensor 1 having bond wires 4 are located between the bond wires 4.

It should be noted that in FIGS. 19-22, the alignment structures can be either in direct contact with the flow sensing die, or can be located within 50 μm from the flow sensing die. Providing the alignment structures within 50 μm of the flow sensing die provides alignment whilst also allowing for manufacturing tolerances of the alignment structures and the flow sensing die. One or more surfaces of the alignment structures or spacers, for example the lower surface or a side surface of an alignment structure, may be located within 50 μm of one of the surfaces, for example the top surface or a side surface, of the flow sensor die.

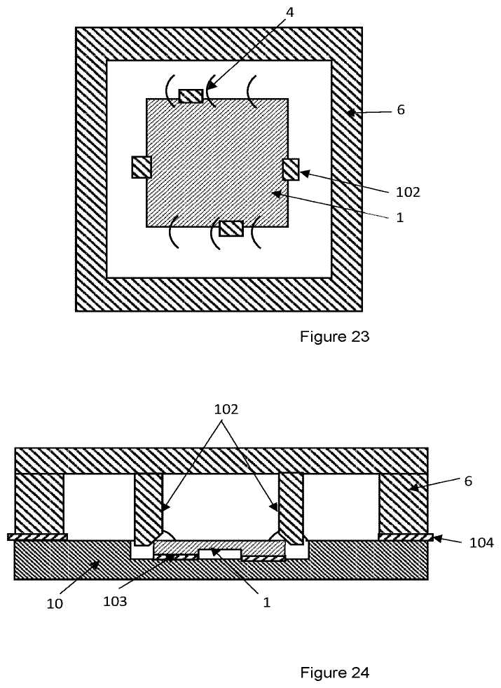

FIG. 23 shows schematically a top view of an alternative flow sensor assembly having horizontal alignment structures, and FIG. 24 shows a cross-section of the flow sensor assembly shown in FIG. 23. In this embodiment, the alignment structures 102 are and aligned with and overlap the side edges of the flow sensor 1. A lower, inner corner of each alignment structure 102 overlapping with a respective corner of the flow sensor 1 is chamfered.

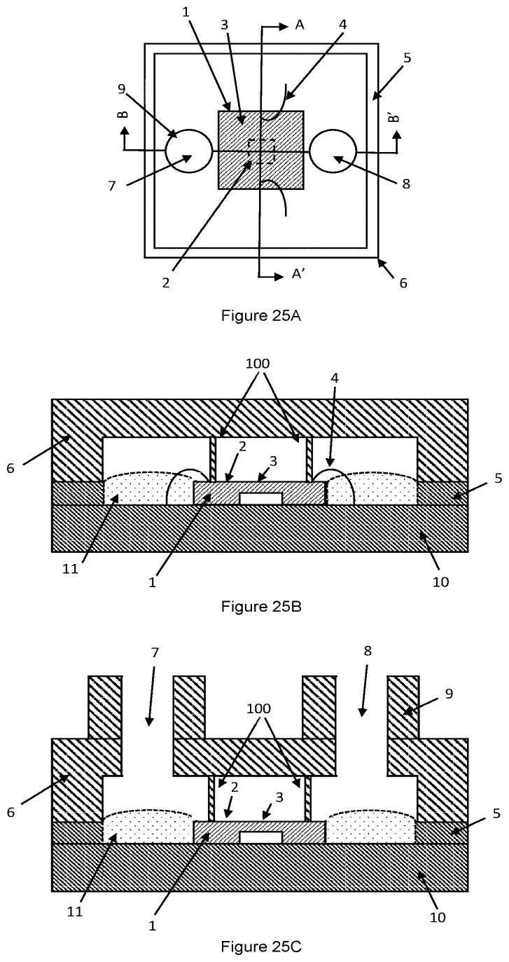

FIG. 25A shows schematically a top view of a flow sensor assembly;

FIG. 25B shows a cross-section of the flow sensor assembly shown in FIG. 25A;

FIG. 25B shows an alternative cross-section of the flow sensor assembly shown in FIGS. 25A and 25B;

FIG. 25A shows a top view of a flow sensor assembly according to an embodiment of the disclosure. The flow sensor assembly includes flow sensing die or flow sensor 1, having a flow sensing surface 3, comprising a membrane 2. The flow sensing die 1 is electrically connected to the substrate (first substrate) with bond wires 4. The substrate comprises a rim 5. The flow sensor assembly also comprises a lid 6, comprising an inlet or flow inlet channel 7 and an outlet or flow outlet channel 8, both comprising hoses 9. Alignment structures 100 (not shown in FIG. 25A) improve the vertical alignment of the lid with respect to the flow sensor.

FIG. 25B shows a schematic cross section of the flow sensor assembly of FIG. 25A along the cut line A-A′, and FIG. 25C shows a schematic cross section of the flow sensor assembly of FIG. 25A along the cut line B-B′. The gap between the rim 5 and the flow sensing die 1 is filled with a filler material 11 with a convex surface topology. As can be seen in FIG. 25B, both the inlet 7 and an outlet 8 have hoses 9.

For connection, the flow sensor assembly has outer bond pads located on an outer surface of the flow sensor assembly. The substrate 10 also has bond pads, referred to as internal bond pads, and the flow sensor may comprise additional bond pads on the dielectric membrane, referred to as die bond pads. The outer bond pads form an electrical connection between the outer surface of the assembly and the internal bond pads of the substrate. The internal bond pads form an electrical connection to the die bond pads through the bond wires.

In the embodiment shown in FIGS. 25A, 25B, and 25C, the flow sensing die is assembled onto a substrate (e.g. a lead frame, a printed circuit board, or any other substrate mechanically supporting the die and offering an electrical connection from the die to the outside world). The substrate comprises a rim. The rim may be integral part of the substrate, integral part of the lid or an additional element assembled onto the substrate as part of the flow sensor assembly process. As a result, a cavity between the rim and the flow sensing die is formed. To reduce turbulences in proximity to the flow sensing surface of the flow sensing die the cavity is filled with a filler material. Depending on the filler deposition method, the surface topology of the filler may be concave or convex. The filler material also protects the substrate bond pads and offers partial protection to the bond wires.

The flow sensor assembly also has a lid with a flow inlet and a flow outlet both comprising hoses to facilitate mechanical connection to the system using it. Hoses may have any geometry that facilitate mechanical connection to the system using the flow sensor assembly. For instance, the hoses may have barbs, grooves, protrusions or a combination of those to enhance friction with the pipes or any other mean connected to them. The number, size and position within the flow sensor assembly of the inlet and the outlet might vary depending on the application requirements.

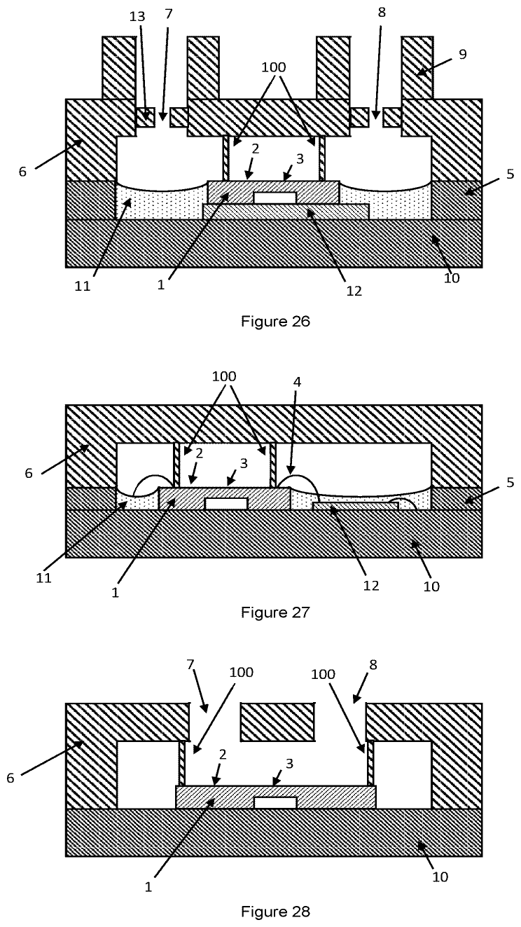

FIG. 26 shows a cross-section of an alternative flow sensor assembly having the inlet and outlet each comprising a restrictor and the flow sensing die stacked on top of the ASIC. This embodiment is similar to that shown in FIG. 25, however in this embodiment, the gap between the rim 5 and the flow sensing die 1 is filled with a filler material 11 with a concave surface topology. The flow sensor assembly also comprises a lid 6, comprising an inlet 7 and an outlet 8, both comprising hoses 9 and channel restrictors 13.

A non-uniform flow channel cross-sectional area is achieved by the use of restrictors (i.e. the flow channel cross-sectional area is locally reduced). Restrictors are placed at the flow inlet and flow outlet to reduce the effect on the flow sensing performance of the flow sensor assembly when integrated into the system using it.

The protrusions or hoses are substantially perpendicular to the flow sensing channel, and the flow inlet channel and flow outlet channel may then be substantially perpendicular to the sensing channel. In this embodiment, fluid enters and exits the flow sensor in opposite directions.

The flow sensing die is stacked on top of the IC die to reduce the overall flow sensor assembly form factor. Alternatively, the flow sensing die and the IC die may be assembled side-by-side, as shown in FIG. 27. In both cases, the filler material offers protection to the IC die.

FIG. 27 shows a cross-section of an alternative flow sensor assembly having the flow sensing die laterally adjacent to the ASIC. This embodiment is similar to those shown in FIGS. 25 and 26, however in this embodiment, the flow sensing die 1 is assembled side by side with an IC 12. The flow sensing die 1 is electrically connected to the IC 12 with bond wires 4. The IC is electrically connected to substrate 10. The gap between the rim 5 and the flow sensing die 1 is filled with a filler material 11 fully covering the IC 12.

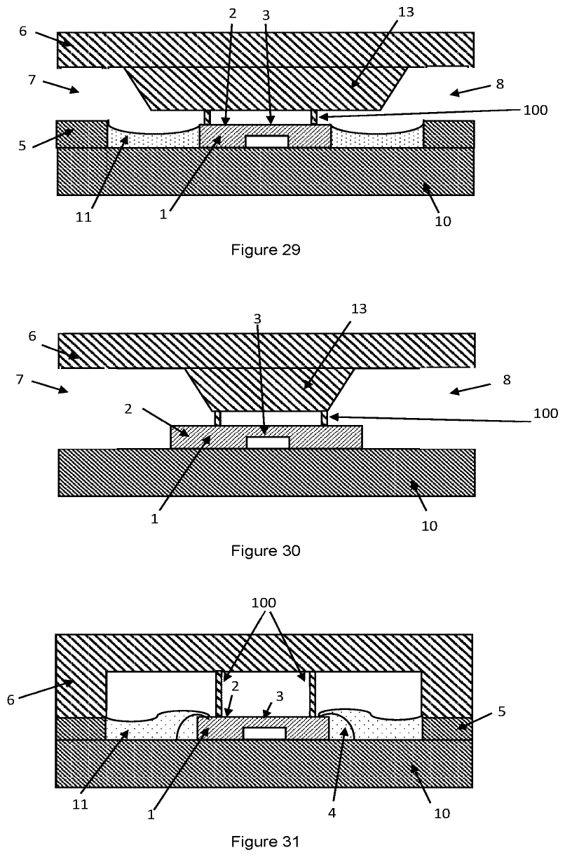

FIG. 28 shows a cross-section of an alternative flow sensor assembly having the inlet and outlet located above the flow sensing die and terminating on the top surface of the lid. This embodiment is similar to those shown in FIGS. 25 to 27, however in this embodiment, the inlet 7 and outlet 8 are both located over the flow sensor 1, which has an integral extension portion to reduce turbulence. The flow sensing die 1 comprises a flow sensing area 3 extending underneath both the inlet 7 and the outlet 8.

In FIGS. 25A to 28, the surface within or around the flow sensor may have a first region underneath the channel inlet 7, and a second region underneath the channel outlet 8, where the surface between the first and second region is substantially flat.

FIG. 29 shows a cross-section of an alternative flow sensor assembly having the inlet and outlet arranged parallel to the flow channel. In this embodiment, the flow inlet channel 7 and the flow outlet channel 8 are defined as the space between the lid 6 and the rim 5. The flow sensor assembly includes a lid restrictor 13.

The lid comprises a restrictor, placed along the flow channel in proximity of the flow sensing surface of the flow sensing die to locally increase the flow speed and thus improve the flow sensing performance. Upon assembly of the lid on the rim of the substrate a flow inlet, a flow outlet, and flow channel are created. The flow sensor assembly described in this embodiment is suitable in applications where the flow sensor assembly is soldered on a surface over which a fluid is flowing, and the application requires measuring a property of the flowing fluid.

FIG. 30 shows a cross-section of an alternative flow sensor assembly having the inlet and outlet arranged parallel to the flow. In this embodiment, the device has a lid restrictor 13, and the flow sensor 1 has an extension portion.

In FIGS. 29 and 30, the flow channel surface around the flow sensor, and in the entire region below the restrictor 13 is substantially flat. The two ends of the restrictor 13 act as a guide for the fluid into the flow sensing channel directly above the flow sensor, and so are the input and output points of the flow sensing channel, and the surface below them is substantially flat.

FIG. 31 shows a cross-section of an alternative flow sensor assembly having filler material completely encapsulating and protecting the bond wires. In this embodiment, the gap between the rim 5 and the flow sensing die 1 is filled with a filler material 11 completely covering the bond wires 4. To reduce turbulences in proximity of the flow sensing surface of the flow sensing die the cavity between the rim 5 and the flow sensor 1 is filled with a filler material 11. Due to surface tension effects, the filler material 11 fully encapsulates the bond wires and the die bond PADs for extra protection. The lid is assembled on the rim of the substrate.

In FIGS. 25B to 31 the alignment structures shown are for vertical alignment. However, other alignment structures such as those shown in FIGS. 13 to 24 may also be used. The alignment structures may also be used for horizontal alignment, or for both horizontal and vertical alignment. The alignment structures can also be used as flow guides.

Furthermore, other types of package design, such as chip scale packages, or packages with through silicon vias or flip chip that don't require wire bonds are also possible.

Further, the structures can also be for alignment to the first substrate rather than the flow sensor chip.

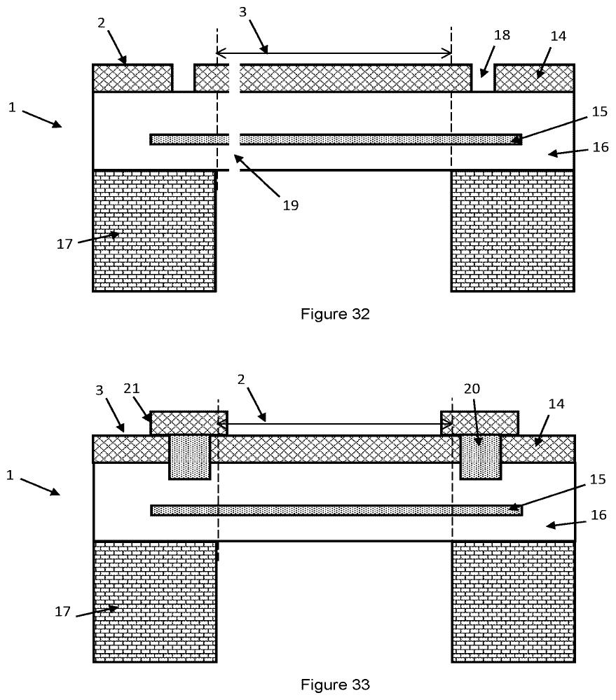

FIG. 32 shows schematically a cross section of a flow sensing die having grooves on the flow sensing die surface. The flow sensing die 1 may be used in any of the flow sensor assemblies shown in FIGS. 1 to 31. The flow sensor 1 comprises a flow sensing surface 3, comprising a membrane 2. The flow sensing die 1 also comprises a passivation layer 14, a metal layer 15 acting as a sensing element embedded within a dielectric layer 16 and a die substrate 17 partly etched through to realise the membrane 2. The passivation layer 14 is also partly etch through to realise grooves 18 on the flow sensing surface 2. The membrane also comprises a through-hole 19.

In this embodiment, grooves are present on the flow sensing surface of the flow sensing die. In case the filler material bleeds onto the flow sensing surface of the flow sensing die, the grooves act as an accumulation volume for the filler material. This avoids interaction of the filler material with the flow sensing structure of the flow sensing surface of the flow sensing die.

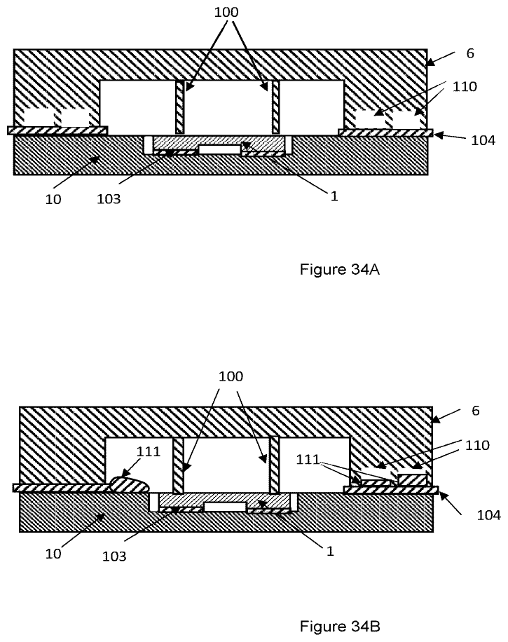

FIG. 33 shows a cross section of a flow sensing die having walls on the flow sensing die surface. The flow sensor 1 comprises a flow sensing surface 2, comprising a membrane 3. The flow sensing die 1 also comprises a passivation layer 14, a metal layer 15 embedded within a dielectric layer 16 and a die substrate 17 partly etched through to realise the membrane 3. The passivation layer 14 is also made non-planar by mean of metal stacks 20 to realise walls 21 on the flow sensing surface 2.

In this embodiment, walls are present on the flow sensing surface of the flow sensing die. In case the filler material bleeds onto the flow sensing surface of the flow sensing die, the walls act as barrier for the filler material thus avoiding interaction of the filler material with the flow sensing structure of the flow sensing surface of the flow sensing die. The walls may be a by-product of a non-planarised fabrication process. For example, metal structures within a metal layer may be realised, resulting in a flow sensing surface with extrusions following the pattern of the metal structures within the metal layer. This effect may be further enhanced if metal structures are realised within different metal layers on top of each other.

It should be noted that while FIGS. 32 and 33 show a flow sensing die with grooves, through-holes and walls, a flow sensing die without these features can also be used for the sensor assemblies shown in FIGS. 1-31.

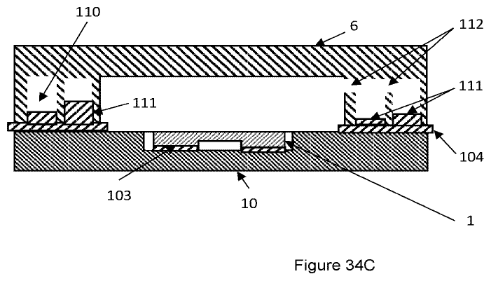

FIG. 34A shows schematically a cross-section of a flow sensor assembly having recesses on the lid to receive adhesive, and FIG. 34B shows a cross section of a flow sensing assembly with excess adhesive present.

FIG. 34A illustrates a flow sensor assembly where the lid 6 has recesses 110. These recesses allow some of the lid attach 104 to escape into the recesses 110. In this way excess lid attach goes into the recesses rather than the flow channel. This improves the reproducibility of the devices and gives a better process window for fabrication.

FIG. 34B illustrates the effect of the epoxy recesses 110 when there is excess lid attach. On the left side of the lid there are no recesses, so the lid attach seeps out as excess epoxy 111 into the flow channel. On the right side there are recesses 110, and the excess epoxy 111 escapes into the recesses rather than into the flow channel.

FIG. 34C illustrates the use of an epoxy recess link 112. On a first side of the flow sensor assembly, shown as the left side in this example, there are no links, so while the lid attach seeps out as excess epoxy 111 in the epoxy recess 110, there is also air trapped in the epoxy recess 110. At high ambient temperatures, or with temperature cycling, pressure can build up inside this cavity, which can cause damage to the lid 6. A solution to this is shown in the right side of the figure where there is a gap or aperture through the sidewall of the epoxy recess 110 in the lid, fluidly connecting the epoxy recess 110 with the flow sensing channel. The gaps may be referred to as epoxy recess links 112. The epoxy recess links 112 may be substantially smaller than the epoxy recesses 110. The epoxy recess links 112 allow air to escape from the epoxy recess 110 and prevent build-up of pressure within the epoxy recess 110.

The skilled person will understand that in the preceding description and appended claims, positional terms such as ‘above’, ‘overlap’, ‘under’, ‘lateral’, etc. are made with reference to conceptual illustrations of a device, such as those showing standard cross-sectional perspectives and those shown in the appended drawings. These terms are used for ease of reference but are not intended to be of limiting nature. These terms are therefore to be understood as referring to a device when in an orientation as shown in the accompanying drawings.

Although the invention has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in the disclosure, whether alone or in any appropriate combination with any other feature disclosed or illustrated herein.

Many other effective alternatives will occur to the person skilled in the art. It will be understood the disclosure is not limited to the described embodiments, but encompasses all the modifications that fall within the spirit and scope of the disclosure.

Reference Numerals

| | |
|---|---|
| 1 | Flow sensor |
| 2 | Dielectric membrane |
| 3 | Flow sensing area |
| 4 | Bond wires |
| 5 | Rim |
| 6 | Lid |
| 7 | Flow inlet channel |
| 8 | Flow outlet channel |
| 9 | Hose |
| 10 | Substrate |
| 11 | Filler material |
| 12 | Integrated Circuit |
| 13 | Channel Restrictor |
| 14 | Passivation Layer |
| 15 | Metal Layer |
| 16 | Dielectric Layer |
| 17 | Die Substrate |
| 18 | Groove |
| 19 | Membrane through-hole |
| 20 | Metal Stack |
| 21 | Walls |
| 100 | Alignment structure |
| 101 | Alignment structure-flow guide |
| 102 | Horizontal Alignment Structure |
| 103 | Die attach |
| 104 | Lid attach |
| 110 | Recess |
| 111 | Excess adhesive |
| 112 | Epoxy Recess Link |
| 200 | Encapsulation |
| 201 | Flow sensing system channel |
| 202 | Restrictor |
| 203 | Guide structure |
| 204 | Protrusion |
| 205 | Additional Flow Path |
| 206 | Main Flow Path |
| 207 | By-pass Flow Path |
| 208 | Fin |
| 209 | Restrictor |
| 210 | Main channel |
| 211 | Protective Coating |
| 212 | Lid recess |
| 302 | Lid-encapsulation surface |
| 304 | Flow sensing channel side-wall |
| 306 | Flow sensing channel lower wall |

1. A flow sensor assembly comprising:
a first substrate;
a flow sensor mounted on a first surface of the first substrate;
a lid located over the first substrate and the flow sensor;
a flow inlet channel;
a flow outlet channel, wherein a surface of the flow sensor and a surface of the lid cooperate to form a flow sensing channel between the flow inlet channel and the flow outlet channel; and
a spacer having:
a first surface located within 50 μm of a surface of the flow sensor; and
a second surface in contact with a first surface of the lid, wherein the first surface of the lid faces the flow sensor.

2. The flow sensor assembly according to claim 1, wherein the first surface of the spacer is in contact with a top surface of the flow sensor, and wherein the top surface of the flow sensor faces the lid.

3. The flow sensor assembly according to claim 1, wherein a second surface of the lid is in contact with a second surface of the first substrate, by way of an adhesive, and wherein the second surface of the lid faces the same direction as the first surface of the lid.

4. The flow sensor assembly according to claim 3, wherein the second surface of lid comprises one or more recesses configured to receive the adhesive.

5. The flow sensor assembly according to claim 3, wherein one or more recesses comprise an aperture within a sidewall of the recess.

6. The flow sensor assembly according to claim 1, wherein the first surface of the spacer is in contact with a top surface of the flow sensor, wherein the top surface of the flow sensor faces the lid, and wherein a bottom surface of the flow sensor is in contact with the first surface of the first substrate, by way of an adhesive, wherein the first surface of the first substrate faces the lid.

7. The flow sensor assembly according to claim 1, wherein the spacer extends from a first inside edge of the lid to a second inside edge of the lid.

8. The flow sensor assembly according to claim 1, wherein the spacer is monolithic with the lid.

9. The flow sensor assembly according to claim 1, wherein the spacer is configured to be within 50 μm of at least one side surface of the flow sensor.

10. The flow sensor assembly according to claim 9, wherein the spacer is in contact with at least one side surface of the flow sensor.

11. The flow sensor assembly according to claim 1, wherein the first surface of the spacer is chamfered.

12. The flow sensor assembly according to claim 1, wherein the spacer is aligned with corners of the flow sensor.

13. The flow sensor assembly according to claim 1, wherein the spacer extends laterally through the flow sensor assembly, parallel to two opposite edges of the flow sensor.

14. The flow sensor assembly according to claim 1, wherein a lower innermost corner of the spacer overlaps with a respective corner of the flow sensor.

15. The flow sensor assembly according to claim 1, wherein the spacer surrounds a respective corner of the flow sensor.

16. The flow sensor assembly according to claim 1, wherein the spacer is aligned with, and overlaps, a side edge of the flow sensor.

17. The flow sensor assembly according to claim 9, wherein the spacer is laterally spaced from a side edge of the flow sensor.

18. The flow sensor assembly according to claim 17, wherein the spacer is aligned with a corner of the flow sensor.

19. The flow sensor assembly according to claim 1, further comprising an overmold laterally encircling the flow sensor and in contact with side walls of the flow sensor, wherein the overmold extends between the flow sensor and the lid such that the overmold, the flow sensor, and the lid define the flow sensing channel.

20. The flow sensor assembly according to claim 19, wherein the lid and the overmold cooperate to define the flow inlet channel and the flow outlet channel.
